(19) United States
(12) Patent Application Publication
(10) Pub. No.: US 2017/0162030 A1
(43) Pub. Date: Jun. 8, 2017

(54) Weapon Monitoring And Notification System

(71) Applicant: Steve Rajnath, Miami, FL (US)

(72) Inventor: Steve Rajnath, Miami, FL (US)

(21) Appl. No.: 15/254,156

(22) Filed: Sep. 1, 2016

Related U.S. Application Data
(60) Provisional application No. 62/262,459, filed on Dec. 3, 2015.

(51) Int. Cl. G08B 21/24; F41C 27/00

(52) U.S. Cl. CPC G08B 21/24; F41C 27/00

(57) ABSTRACT

A weapon storage system that monitors the location and status of individual weapons in an inner perimeter (inside a storage safe, a locked room, a locked cabinet, etc.) and the location and status of individual weapons in a larger perimeter (the property where the storage safe is located). Each weapon has a tracking device that identifies it to a weapon monitor. A controller communicates to the weapon owner via multiple channels, including an audible alarm in the controller, text, email, and/or communication to mobile devices such as a smart phones, etc, when the system detects that a weapon has been moved or is not in a secure location. The weapon owner is automatically reminded of the weapon's status when a weapon is not in the proper location.

### CROSS-REFERENCE TO RELATED APPLICATIONS

This application is related to, and claims the benefit of, the provisional patent application entitled “Weapon Monitoring And Notification System”, filed Dec. 3, 2015, bearing U.S. Ser. No. 62/262,459 and naming Steve Rajnath, the named inventor herein, as sole inventor, the contents of which is specifically incorporated by reference herein in its entirety.

### BACKGROUND OF THE INVENTION

Technical Field

The Weapon Monitoring and Notification System is a secure method of storing and controlling access to weapons. In particular, it provides a monitoring and notification system that detects when weapons are not properly secured, and alerts the party responsible for securing the weapon that action needs to be taken when a weapon is not in the proper location, either in a weapon safe or at another location within a residence or facility. Further, it can also be used in conjunction with conventional weapon storage safes to monitor the status of the safe, to monitor the status of individual weapons within the safe, and to alert weapon owners as to the status of the weapons and/or the weapon's location.

Background

Currently, approximately one third of U.S. households contain a weapon, and approximately half of those weapon-owning households don't lock up their weapons. Likewise, about 40 percent of households have children that are under age 18. As a result, there are millions of households in which minors have access to weapons. This combination of widespread weapon ownership and questionable storage practices (i.e., storing loaded weapons where they are easily accessible) are associated with higher rates of unintentional shooting deaths.

Due to the safety hazard created by the easy access to weapons, it would be desirable to improve weapon safety by having a system that reminds authorized individuals to store weapons properly, and if necessary, alert them when weapons are not in a designated safe storage location.

While the prior art has provided storage facilities for weapons, it has failed to provide a system that monitors weapons and alerts authorized parties as to the location, movement and status of weapons regardless of their location.

### SUMMARY OF THE INVENTION

The present invention provides a weapon storage system that monitors the location and status of individual weapons and reminds weapon owners when their weapons are not properly stored. The system may optionally use a storage safe, or specific location such as an office, a designated room, etc. The system also uses an outer perimeter that may be a residence, a commercial, or even a vehicle such as an RV, etc. Each weapon has a tracking device that identifies it to a remote controller. The remote controller communicates to the weapon owner via multiple channels, including an audible alarm in the controller, text, email, and/or communication to mobile devices such as a smart phones, etc, when the system detects that a weapon has been moved. The weapon owner monitors the weapon's location via a local controller, or via a software application in a smart phone.

### BRIEF DESCRIPTION OF THE DRAWINGS

FIG. 1 illustrates a preferred embodiment that monitors weapons and reminds responsible parties when weapons may be improperly stored.

FIG. 2 illustrates an alternative embodiment in which a monitor determines when weapons are securely stored.

FIG. 3 is a block diagram of an alternative embodiment of the invention that illustrates data flow and conductivity of the invention when using stickers.

FIG. 4 is a block diagram of an alternative embodiment of the invention that illustrates data flow and conductivity of the invention when using beacons.

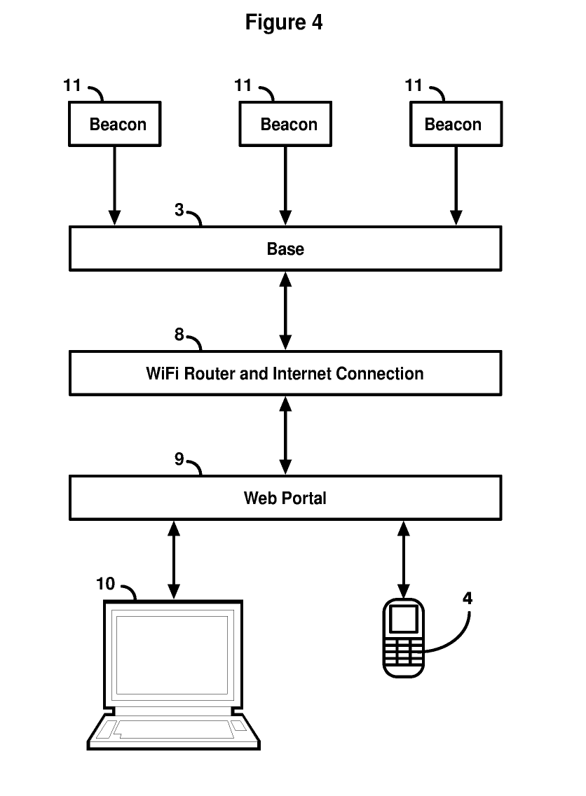

FIG. 5 illustrates a preferred embodiment of the invention in which a beacon is secured to the barrel of a weapon. An optional combination keypad or biometric sensor is also illustrated to show how the beacon can be detached from the weapon.

FIG. 6 illustrates an alternative preferred embodiment of the invention in which a sticker or beacon is secured to the trigger mechanism of a weapon.

FIG. 7 illustrates an alternative preferred embodiment of the invention in which a sticker or beacon is concealed inside of a weapon such that an authorized user will not be able to detect its presence.

### DESCRIPTION OF THE PREFERRED EMBODIMENT

Prior to a detailed discussion of the figures, a general overview of the invention will be presented. The invention encourages and enables safe weapon storage habits by providing a Weapon Monitoring and Notification System that automatically reminds authorized individuals when a weapon is not safely stored. By reminding the authorized individual when this happens, the possibility of serious weapon accidents is reduced.

Occasionally, the owner of a weapon may return home, but forget to place their weapon within a predetermined safe storage area. The invention is designed to remind users who forget to store weapons safely. The invention alerts weapon owners if their weapon is not in the proper storage location.

For ease of discussion, the term “safe zone” will be used to refer to a lockable storage area such as a safe, and the term “large perimeter” will be used to refer to a predetermined area around the safe zone, such as a room, a floor a building, an area surrounding the building, etc. As used herein, the term “sticker” denotes a Communication Device attached to a weapon with a unique identification code that can be electronically read. In addition, the term weapon is intended to encompass any type of weapon, such as a pistol, a rifle, a shotgun, knives, or any other type of weapon that needs to be secured. A general overview of the invention is as follows:

1. There will be two established perimeters by the system. The owner is alerted when weapon is within larger perimeter of property, but the weapon is not in the smaller storage perimeter. This function enables the owner to remember to safely store guns that are on the property but not in the storage area.

2. The owner is also notified if the weapon is removed from the safe zone at any time.

3. The owner is alerted via a mobile app and physical audible alert when a weapon is removed from storage perimeter and/or in the larger perimeter but not in storage zone.

4. The owner can optionally decide to turn off or snooze alarms/alerts at the owner's discretion.

5. The mobile app can control some functions, like alerts or individual stickers that are attached to specific weapons.

6. In the preferred embodiment, the safe zone is sized to accommodate up to five stickers (one per weapon). However those skilled in the art will recognize that the number of stored weapons can vary widely depending on the owner's situation. For example, an individual may have only one or two weapons in a private dwelling office that will require only a relatively small safe zone. However, in large organizations such as a military armory, the safe zone may be substantially larger such that it can accommodate hundreds of weapons, each weapon having unique electronic identification code within their associated stickers.

7. The invention can be used in hey variety of locations, such as mobile homes, private homes and dwellings, commercial establishments, and larger facilities such as police, government, and/or military installations.

8. While the invention is discussed in terms of weapons, it extends beyond providing security for weapons. Those skilled in the art will recognizes that the invention can also be used to secure not only weapons but anything of high-value, such as artwork, securities, coins, jewelry, etc. The invention can be used in any application where the user needs to be reminded about the location of any object as well as notification if any object is removed from its storage location.

9. The owner can be notified via an alarm or any other suitable form of notification if the store weapon or other object is within the larger perimeter but not within the safe zone, or if the weapon or object is moved outside of the safe zone or larger perimeter.

In the preferred embodiment, the invention uses the following components to accomplish its intended purpose:

An electronic base unit (“base”) located in, on, or in close proximity of the safe zone location. The base preferably has a Power Indicator Light and a Rotary Dial to change the distance/sensitivity of the safe zone area as well as a second Rotary Dial to adjust the distance/sensitivity of the Reminder or Home Zone. The Device also preferably has a battery back up power supply such that it will work independently on plugged in or battery power. The range of the storage zone can be adjusted but depends on interference from other factors such as wall construction, the type of safe, etc.

In the preferred embodiment the Device includes an audible alarm built into the base, but is also in communication with a mobile App that alerts the user via their mobile device when status of the weapons storage system has changed.

Communication with a weapon or other object is enabled by attaching a sticker to weapon or other object on or inside of the weapon or other item. In the preferred embodiment, the sticker is fabricated such that if broken or otherwise damaged, as is case when an unauthorized person is attempting to remove the sticker, the sticker automatically triggers an alarm when damage is detected.

Having discussed the features and advantages of the invention in general, we turn now to a more detailed discussion of the figures.

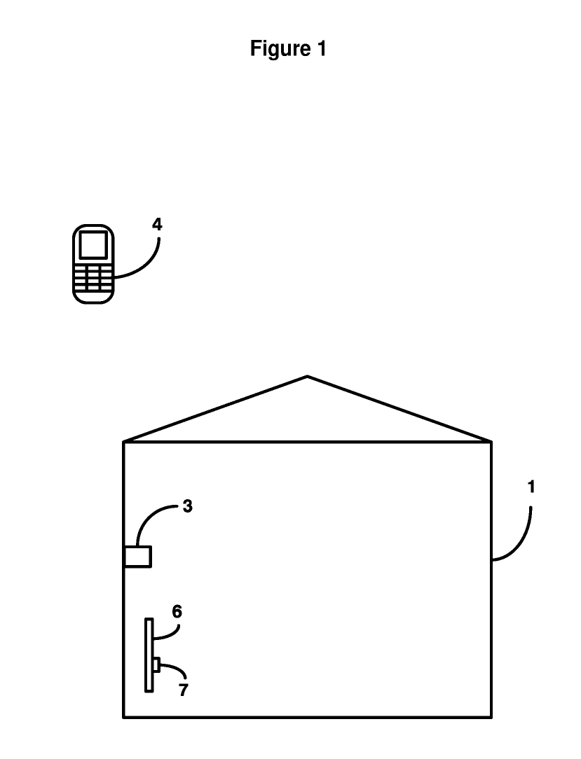

In FIG. 1, the preferred embodiment of the invention is shown in which a base (i.e., a monitor/communication controller) 3 is located within a dwelling 1. Also shown is a weapon 6 that is located in a designated area within the dwelling number 1. Each weapon 6 (there may be several in the dwelling) has a unique sticker 7 attached to it. The base 3 monitors the location of each weapon 6. When the base 3 detects that a weapon 6 is out of place or has moved, it contacts the party responsible for the weapon 6 to remind them that the weapon 6 is not properly stored. In this figure, the reminder is sent from the base 3 to a remote smart device 4. In this example, the remote smart device 4 as a smart phone, but it could also be notebook computer, tablet computer, a pager, etc. Those skilled in the art will realize that the reminder can be sent via any number of suitable methods, such as voicemail, text message, SMS message, email, etc. By quickly communicating the change in status of the weapon, the possibility of accidental injury due to careless handling of weapons 6 is reduced.

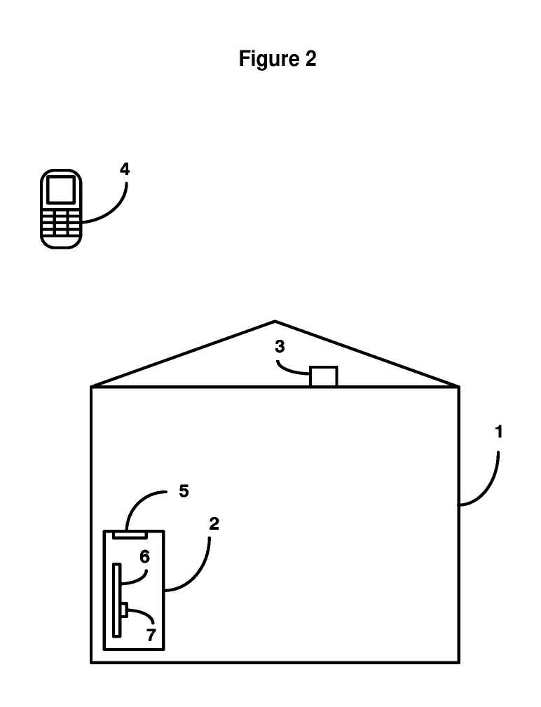

FIG. 2 illustrates an alternative embodiment in which weapons 6 are secured in storage safe 2 (or suitable alternative location, such as a locked room, a lockable cabinet, etc.). In this figure, storage safe 2 is located inside the dwelling 1. In addition, a base 3, and a remote smart device 4 are shown. In this embodiment, the storage safe 2 provides secure storage for a variety of weapons 6 for other items 6 that would benefit from secure storage. Each weapon 6 or other item has a unique sticker 7 attached to it.

The sticker 7 can be an RFID (Radio frequency identification) tag, an NFC (Near Field communication) device, or any other suitable technology. Further, each sticker 7 has a unique code number that is associated with a particular weapon 6 or other item it is attached to. The sticker 7 communicates with a weapons monitor 5. In turn, the weapons monitor 5 communicates with the base 3. Each weapon 6 or other item in the storage safe 2 has its own sticker 7 attached to it that allows the weapons monitor 5 to know exactly which weapon 6 has been removed from the storage safe 2. Once removed from the storage safe 2, the weapons monitor 5 informs the base 3 that a particular weapon 6 or other item has been removed. The base 3 then communicates with the authorized party that controls the storage safe 2 via any suitable communications channel, Including voice messages coming text messages, emails, etc. In this figure, the base 3 communicates the authorized party via cell phone 4. Those skilled in the art recognize that any suitable stickers 7 can be used, and the number of stickers 7 may vary based on the size of storage safe 2.

When a weapon 6 is removed from the storage safe 2, the weapons monitor 5 notifies the communications controller 3 that in turn notifies cell phone 4. When the authorized party receives word that a weapon 6 has been removed from the storage safe 2, the authorized party can take action. If home, the authorized party can immediately examine the storage safe to make sure that nothing is missing. On the other hand, if something has been taken, the authorized party can take appropriate action, such as checking to see if any children in the house have the missing item, or if the item is no longer on the premises.

As shown in FIG. 2, the base 3 is remotely located from the storage safe 2. Placing the base 3 in a remote location reduces the possibility that an intruder would be able to interfere with its operation. Further, in the preferred embodiment, base 3 communicates with the weapons monitor 5 on a predetermined time schedule. In the event that the base 3 cannot contact the weapons monitor 5 due to device failure or to damage to the device by an unauthorized party, the base 3 will then communicate directly to the authorized party with status. Of course, those skilled in the art will realize that the weapons monitor 5 and the base 3 can alternatively be combined into a single device, as shown in FIG. 1.

In similar fashion, the weapons monitor 5 periodically communicates with each sticker 7. If for any reason the weapons monitor 5 his unable to communicate with all of the stickers 7, then the weapons monitor 5 will alert the base 3. In a preferred embodiment, stickers 7 are fabricated such that when they are removed from a weapon 6 or other item, they will break and cease to communicate with the weapons monitor 5. As a result, an intruder cannot defeat the system by breaking or removing the sticker 7.

In this preferred embodiment, the storage safe 2 provides a primary perimeter in the weapons storage system. In addition, a secondary perimeter is defined by the entire dwelling 1. By establishing a storage safe 2 as the primary perimeter and dwelling 1 as the secondary perimeter, the system is specifically able to determine, alert and remind the authorized user if a weapon 6 is within the dwelling 1 but not securely stored in the storage safe 2. When a weapon 6 or other item is removed from the storage safe 2, the base 3 monitors the weapon 6 as it moves within the dwelling 1. Those skilled in the art will recognize that the location of a weapon 6 within the secondary perimeter, and not within primary perimeter, can also be monitored by the weapons monitor 5.

Another advantage provided by the system is that it tracks the location of the weapon 6 or other item within the secondary perimeter. In the event that the storage safe 2 was not properly locked, and a child removed the weapon 6 from the storage safe 2, the authorized party can be immediately notified so that they could retrieve the weapon 6 before any harm can accidentally be done by or to a child.

In addition to the electronic notification, discussed above, the system also optionally provides audible alarms that can be activated immediately upon movement of a weapon 6 or other item.

The foregoing discussion referred to weapons 6 and/or other “Items.” Other items can be anything of value, such as artworks, gold coins, jewelry, family heirlooms, Etc. These items would often have substantial commercial value, but may also be items having a great personal value with no commercial value at all (e.g., family photos, documents, mementos, etc.).

In the preferred embodiment, the system has the capability of manually adjusting the size of the secondary perimeter. This feature is important because dwellings can vary greatly in size. Therefore, the ability to adjust the size of the secondary perimeter provides the ability to customize the size of the area being protected.

While the system would normally use household power for operation of its various components, those skilled in the art will recognize that battery backups would preferably be included in the system to protect against power outages.

For ease of illustration, the invention was described as having a weapons monitor 5 and a base 3. However, those skilled in the art will recognize that the weapons monitor 5 and the base 3 can be implemented as a single device.

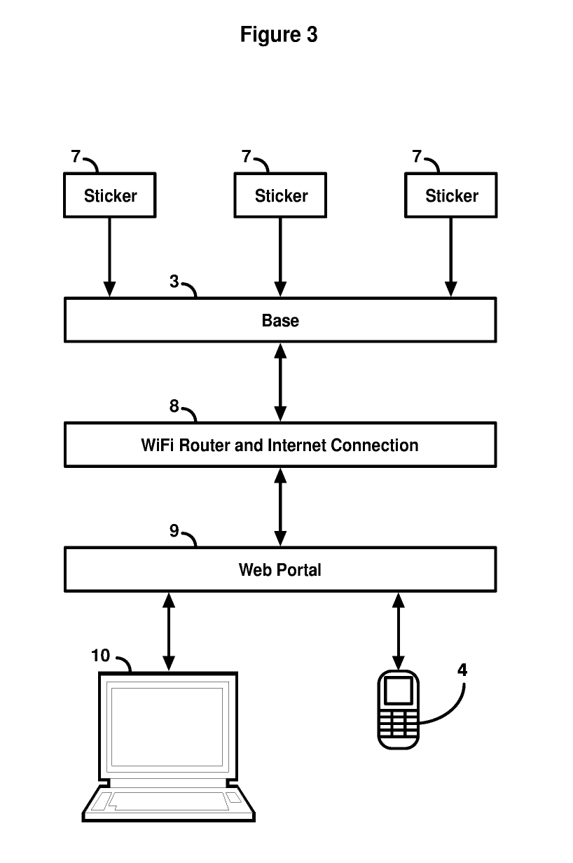

FIG. 3 is a block diagram of an alternative embodiment of the invention that illustrates system requirements, data flow and connectivity of the invention. In this figure, three stickers 7 are shown. Of course, the number of stickers 7 used in any given application will be depend on the number of weapons or other items being stored. Each weapon or other item will be stored in a safe location, such as a safe, locked cabinet etc. Each sticker will communicate with the base 3 using any suitable technology, such as RFID (passive or active), NFC (passive or active), or Bluetooth, etc. Both passive and active 7 can be polled by the basement 3 at preselected time intervals and return data indicating their location and/or status. The base 3 can be located anywhere that is suitable to communicate with the stickers 7. The only requirement is that the base 3 is sufficiently close to the stickers 7 such that they can establish communication between them.

When the base determines that a weapon or other item has been moved, or that the sticker 7 has been damaged, it will immediately establish contact with the Internet using a local Wi-Fi router 8. In turn, the Wi-Fi router 8 will establish connection with a web portal 9 that services a communications device used by an authorized party, such as a cellular telephone 4 or a computer terminal 10. The advantage of this embodiment is that it makes use of pre-existing Internet infrastructure and pre-existing wireless routing technology. The only additional hardware required to implement this embodiment are the stickers 7 and the base 3.

The Internet infrastructure used by the invention allows an authorized party been notified regardless of where they are. Set cellular telephones 4 can be contacted at any location, and computers 10 and also be located anywhere as well as being portable. As a result, the authorize party can be instantly alerted 10 weapon or other item is removed from the safe storage location. This allows Quick response by the authorized party to avoid any mishandling or theft of stored items.

Another preferred embodiment of the invention uses intelligent beacons 11. The Beacon 11 serves the same function as the sticker 7 except that it incorporates additional intelligence to dynamically monitor the weapon or other item that it is attached to, and to automatically notify the base 3 when motion has been detected. In this embodiment, the beacons 11 are powered and automatically contact the base 3 on a preselected time schedule, and/or automatically contact the base 3 when they detect movement of the beacon 11. In this embodiment, the link between the beacon 11 and the base 3 uses Bluetooth technology. However, those skilled in the art will recognize that any other suitable Communications technology may be used.

In this preferred embodiment, the beacon 11 has the following requirements:

1. Each beacon 11 broadcasts every thirty seconds.

2. If the base 3 loses contact with the beacon 11 for more than ninety seconds, a missing device alert is generated by the base 3 and the authorized party is then notified. Those skilled in the art will recognize that the time intervals may preferably be programmable by the user.

The beacons 11 are preferably motion-sensitive. When a beacon 11 detects motion, a system alert is generated. Further, when a beacon 11 detects motion, it automatically wakes up and broadcasts the change in status to base 3. The beacon 11 then continues to broadcast every thirty seconds while motion is detected. If no motion is detected for a full thirty-second period, then the beacon 11 will wake up and broadcast immediately on the next motion detection cycle.

3. In the preferred embodiment, the projected battery life of the beacon 11 is five years under normal conditions. Normal conditions assumes that the beacon 11 is in motion less than ten percent of the time, and operating at room temperature.

In this preferred embodiment, the base 3 would preferably have the following requirements:

1. The base 3 is preferably capable of tracking at least 100 beacons 11 simultaneously. Of course, the base 3 can be designed to support more or less beacons 11 depending on the needs of the particular application's needs.

2. As was the case in the previous embodiment, the base 3 periodically communicates to the web portal 9 at a configurable rate, via the Wi-Fi router and Internet connection 8. For example, every thirty seconds.

3. When a beacon 11 indicates a new alert condition (e.g., motion, device missing, etc), the base 3 reports the alert immediately to the web portal 9. When the alert is received at the web portal 9, it in turn notifies the responsible party via cellular telephone 4 or computer 10.

4. If a new weapon or other item is added to the items currently being protected the base 3 identifies it's presence based on a unique identifying code within the beacon 11. When the new beacon 11 is read by the base 3, the base 3 reports immediately to the web portal 9 which then updates its List of items being secured.

5. In a large embodiment of the invention, such as in large corporations, police organizations, military organizations, etc., a variety of bases 3 are provided that support either internet connection via WiFi, 2G/3G GSM cellular (e.g., AT&T, T-Mobile, international) or 3G CDMA cellular (Verizon). Of course, so skilled in the art will recognize that as new communications technologies emerge, They can easily be incorporated into this system so long as they are compatible with the Internet.

6. WiFi base 3 provide a user interface to configure which access point should be used to access the internet. This interface conforms to the following: a) The user puts the base 3 in configuration mode by pressing and holding physical button for 6 seconds, and b) while in configuration mode, the base 3 provides an ad-hoc access point with a known SSID. The user connects to the base 3 with a WiFi-capable device (e.g., a computer, smartphone, tablet, etc.) and opens a given IP address in a web browser.

In this preferred embodiment, the web portal 9 would preferably have the following requirements:

1. The web application provides an interface for end users to register their hardware and create an account.

2. Beacons 11 that report to bases 3 registered with the user's account are automatically added to the same account.

3. The web portal 9 captures and stores data history from bases 3 and beacons 11 for up to 3 years. However this time period can change based on design choices.

4. The beacons 11 provide information related to signal presence, signal strength, battery status and motion.

5. The user can assign fixed positions to bases 3. The positions can be presented in a map view with the bases 3 displayed at their fixed position. Cellular bases 3 may be able to determine their location automatically using GPS.

6. The web portal 9 includes a notification engine that notifies users in response to system events of their choosing.

7. The data output can be customized for different organizations, individuals, and output devices such as cellular telephones 4 and computers 10.

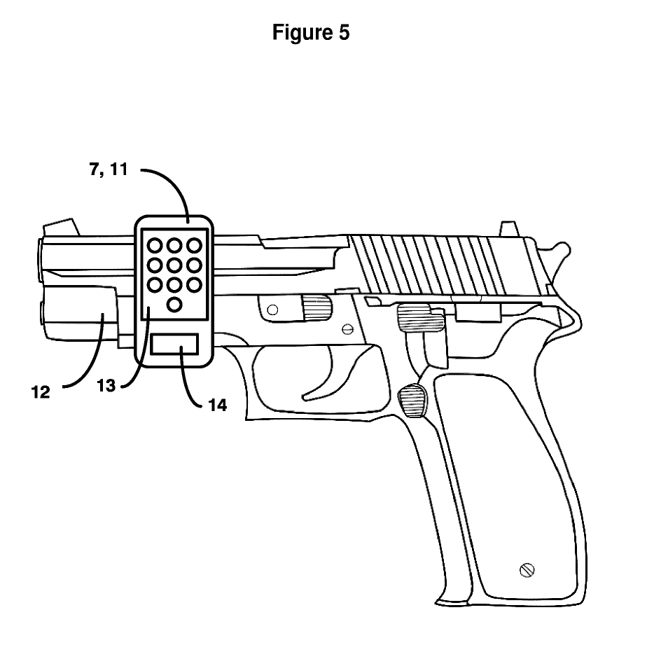

FIG. 5 illustrates a preferred embodiment of the invention in which a sticker 7 or a beacon 11 is secured to the barrel of a weapon 12. An optional combination keypad 13 or biometric sensor 14 is also illustrated to show how the sticker 7 or beacon 11 can be unlocked and detached from the weapon 12. However, any suitable locking mechanism can be used. When the weapon 12 is removed from the storage safe 2, it would normally trigger an alert to the authorized party that a weapon was being removed. However, by entering the correct code into the keypad 13, or entering the correct biometric data into the fingerprint scanner 14, the beacon 11 will recognize that an authorized party has detached the beacon 11 from the weapon 12 and merely update the system status.

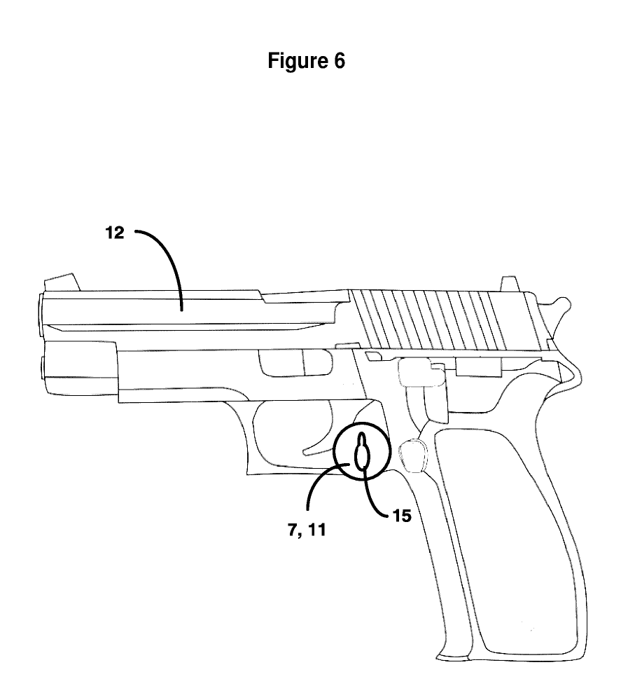

FIG. 6 illustrates an alternative preferred embodiment of the invention in which a sticker 7 or beacon 11 is Incorporated into a conventional trigger lock 15 of a weapon 12. This embodiment prevents the weapon 12 from being fired unless the trigger lock 15 is properly removed. While this illustration shows a conventional keyed trigger lock 15, those skilled in the art will recognize that any other suitable locking mechanism can also be used, such as a keypad 13 (shown in FIG. 5), or a biometric lock 14 (also shown in FIG. 5). By concealing the sticker 7 or beacon 11 inside what appears to be a conventional trigger lock 15, an unauthorized party will not be aware that the weapon 12 it is communicating with the base 3.

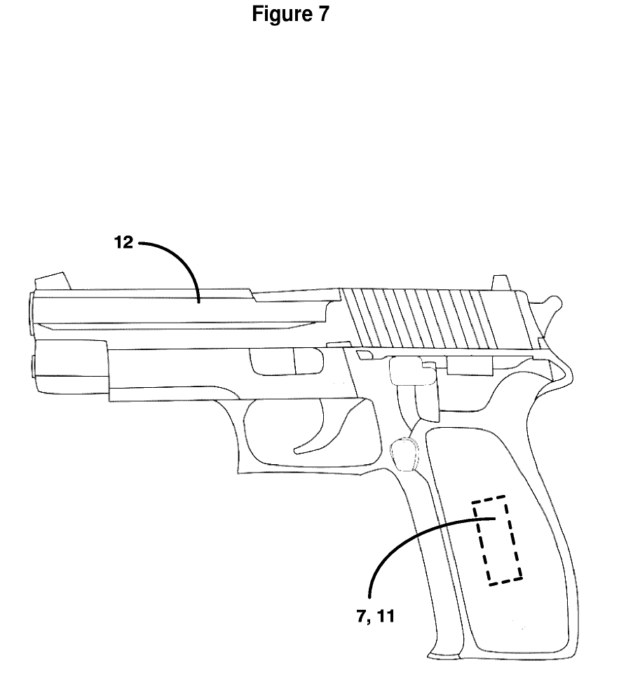

FIG. 7 illustrates an alternative preferred embodiment of the invention in which a sticker 7 or beacon 11 is concealed inside of a weapon 12 such that an authorized user will not be able to visually detect its presence. In this illustration, the sticker 7 or beacon 11 is shown in dashed lines to indicate that it is concealed underneath the handle of the weapon 12.

As shown in FIGS. 5-7, there are a number of ways to secure a sticker 7 or beacon 11 to a weapon 12. The best method will most often be determined by the nature of the storage facility. For example, what works best for a private residence would not necessarily be appropriate for military armory.

As can be seen from the foregoing embodiments, the invention provides a secure storage system for weapons and other valuable items that automatically monitors location of those items, and it immediately notifies authorized personnel when unauthorized access to those items has happened. In addition, the invention provides a much safer environment for storing potentially dangerous items such as weapons.

While the invention has been described with respect to a preferred embodiment thereof, it will be understood by those skilled in the art that various changes in detail may be made therein without departing from the spirit, scope, and teaching of the invention. For example, the material used to fabricate the device can vary, etc. Accordingly, the invention herein disclosed is to be limited only as specified in the following claims.

I claim:

1. A weapons storage system, comprising:
a weapons monitor;
a communications monitor in communication with the weapons monitor;
at least one identification tag for attachment to a weapon or other item; and
the weapons monitor in communication with the identification tags, such that when the weapons monitor determines that the identification tag has been removed from the storage site, the weapons monitor notifies the communications monitor which then notifies a remote device that a weapon has been moved;
whereby movement of a weapon results in the authorized party being reminded to properly secure the weapon.
